(19) United States
(12) Patent Application Publication
(10) Pub. No.: US 2008/0083241 A1
(43) Pub. Date: Apr. 10, 2008

(54) Air conditioning apparatus for vehicle

(75) Inventors: Kyoko Nagata, Kariya-city (JP); Yukio Uemura, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/973,287

(22) Filed: Oct. 8, 2007

(30) Foreign Application Priority Data
Oct. 10, 2006 (JP) 2006-276387

(51) Int. Cl. B60H 1/32

(52) U.S. Cl. 62/271; 165/63

(57) ABSTRACT

An air conditioning apparatus for a vehicle has a unit case, a heat exchanger for generating a heated air, a bypass passage through which a bypass air flows while bypassing the heat exchanger, and a baffle member having first passages and second passages. The unit case has openings for introducing a conditioned air into a passenger compartment. The openings are aligned in an alignment direction across a width of the unit case. The first passages and second passages are alternately arranged in the alignment direction. One of the bypass air and the heated air has an uneven distribution of a flow speed in the alignment direction at a position upstream of the baffle member, and flows in the first passages. Widths of the first passages are varied according to the distribution of the flow speed.

### CROSS REFERENCE TO RELATED APPLICATION

This application is based on Japanese Patent Application No. 2006-276387 fired on Oct. 10, 2006, the disclosure of which is incorporated herein by reference.

### FIELD OF THE INVENTION

The present invention relates to a vehicular air conditioning apparatus of an air mixing type.

### BACKGROUND OF THE INVENTION

For example, a vehicular air conditioning apparatus of an air mixing type has an evaporator for cooling air blown by a blower, a heater core for heating air cooled by the evaporator, a bypass passage through which the cooled air flows to bypass the heater core, and an air mixing door, within a unit case. The air mixing door is operable to adjust a ratio of the volume of the cooled air passing through the bypass passage to the volume of the heated air passing through the heater core, thereby to control a temperature of air to be blown into a passenger compartment of a vehicle. Hereafter, the air, the temperature of which is controlled, is referred to as a conditioned air. Such an air conditioning apparatus is, for example, described in Unexamined Japanese Patent Publication No. 2005-104250.

In the disclosed air conditioning apparatus, the unit case further has an air mixing chamber for mixing the cooled air and the heated air. The mixed air, that is, the conditioned air is blown out from air-blowing openings and introduced into the passenger compartment. In the air mixing chamber, a baffle member is disposed to improve the mixing of the cooled air and the heated air.

The baffle member defines cooled air main-flow passages through which the cooled air mainly flows and heated air main-flow passages through which the heated air mainly flows. The cooled air passages and the heated air passages are alternately arranged in a direction, such as, in a vehicle right and left direction. The cooled air passing through the cooled air passages and the heated air passing through the heated air passages are effectively mixed, and the mixed air further flows toward the air-blowing openings.

In the disclosed air conditioning apparatus, distribution of flow speed of the cooled air that has passed through the bypass passage will be uneven in the vehicle right and left direction due to shapes of inner wall surfaces of the unit case, a bending shape of passages, and the like. In a case that widths of the cooled air main-flow passages and the heated air main-flow passages of the baffle member are uniform, that is, cross-sectional areas of the cooled air main-flow passages and the heated air main-flow passages defined in a direction perpendicular to the flow direction of the cooled air and the heated air, are uniform, the cooled air passes through the baffle member while having the uneven distribution of the flow speed. Therefore, the mixed air passes through the air-blowing openings from the air mixing chamber and is blown into the passenger compartment, while having the uneven distribution of the flow speed. As a result, the temperature of the conditioned air is not uniform in the vehicle right and left direction due to the uneven distribution of the flow speed.

### SUMMARY OF THE INVENTION

The present invention is made in view of the foregoing matter, and it is an object of the present invention to provide an air conditioning apparatus for a vehicle, having a structure that is capable of reducing unevenness of temperature of air to be blown into a passenger compartment.

According to an aspect of the present invention, a vehicular air conditioning apparatus includes a unit case, a heat exchanger, a bypass passage, an air mix door, a plurality of air-blowing openings, and a baffle member. The heat exchanger is disposed in the unit case for generating a heated air. The bypass passage is provided in the unit case for allowing a bypass air to flow while bypassing the heat exchanger. The air mix door is disposed in the unit case and operable to control a ratio of the volume of the bypass air to the volume of the heated air, thereby to control a temperature of air to be introduced into a passenger compartment of a vehicle. The plurality of air-blowing openings is aligned in an alignment direction, and allows a conditioned air, a temperature of which has been controlled, to flow toward the passenger compartment. The baffle member is disposed in the unit case and defines a plurality of first passages and a plurality of second passages. The plurality of first passages and the plurality of second passages are alternately disposed in the alignment direction. One of the bypass air and the heated air has an uneven distribution of a flow speed with respect to the alignment direction at a position upstream of the baffle member, the one flowing in the plurality of first passages, and the other of the bypass air and the heated air flowing in the plurality of second passages. Further, one of the first passages that is located at a position corresponding to a relatively low flow speed has a width with respect to the alignment direction greater than a width of another one of the first passages that is located at a position corresponding to a relatively high flow speed.

Accordingly, the volumes of air flowing into the first passages are substantially uniform. As such, at a position downstream of the baffle member, unevenness of temperature of mixed air of the bypass air and the heated air with respect to the alignment direction is reduced. Accordingly, temperatures of airs passing through the openings toward the passenger compartment are substantially uniform.

According to a second aspect of the present invention, a vehicular air conditioning apparatus includes a unit case, a heat exchanger disposed in the unit case for generating a heated air, a bypass passage provided in the unit case for allowing a bypass air to bypass the heat exchanger, and a baffle member disposed at a position downstream of the bypass passage and the heat exchanger in the unit case. The unit case includes a plurality of openings that is aligned in an alignment direction across a width of the unit case. The baffle member defines a plurality of first passages and a plurality of second passages. The plurality of first passages and the plurality of second passages are alternately disposed in the alignment direction. In the unit case, one of the bypass air and the heated air has an uneven distribution of a flow speed with respect to the alignment direction at a position upstream of the baffle member, the one flowing in the plurality of first passages, and the other of the bypass air and the heated air flowing in the plurality of second passages. Widths of the plurality of first passages in the alignment direction are varied according to the distribution of the flow speed.

Accordingly, the volumes of air flowing into the first passages are substantially uniform. As such, at the position downstream of the baffle member, unevenness of temperature of mixed air of the bypass air and the heated air with respect to the alignment direction is reduced. Accordingly, temperatures of airs passing through the openings are substantially uniform.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a cross-sectional view of an interior unit of an air conditioning apparatus according to a first embodiment of the present invention;

FIG. 2 is a schematic cross-sectional view of the interior unit taken along a line II-II in FIG. 1;

FIG. 3 is a graph for showing effects of a baffle member of the interior unit according to the first embodiment;

FIG. 4 is a schematic cross-sectional view of an interior unit of an air conditioning apparatus according to a second embodiment of the present invention;

FIG. 5 is a schematic cross-sectional view of an interior unit of an air conditioning apparatus according to a third embodiment of the present invention; and

FIG. 6 is a schematic cross-sectional view of an interior unit of an air conditioning apparatus according to a fourth embodiment of the present invention.

### DETAILED DESCRIPTION OF EXEMPLARY EMBODIMENTS

### First Embodiment

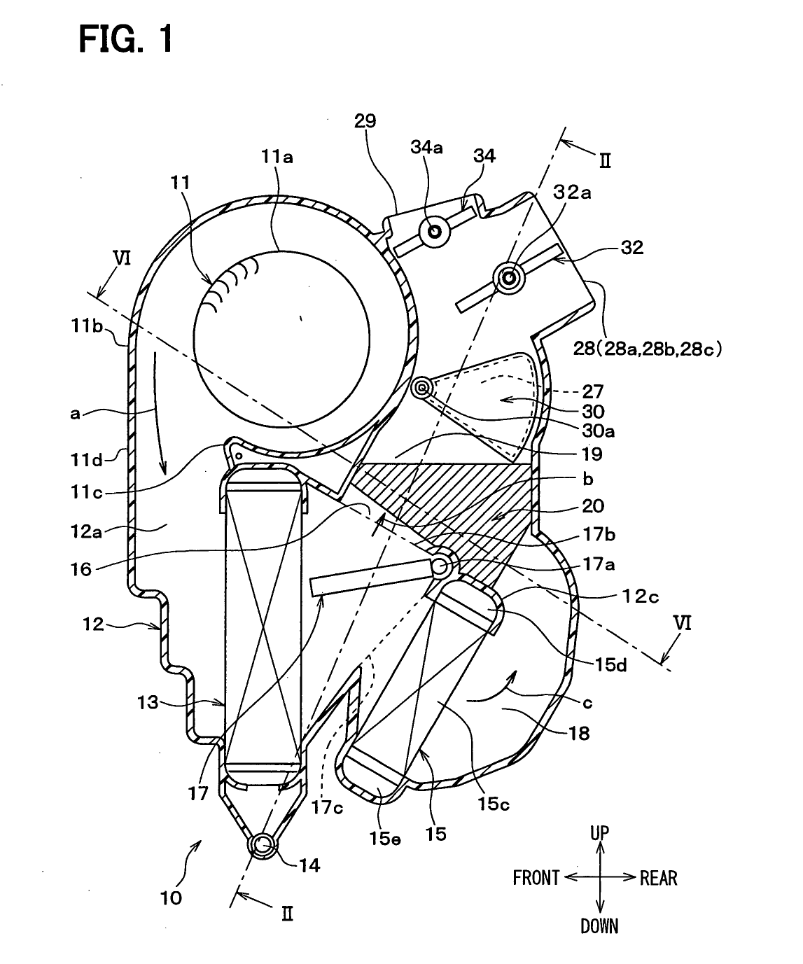

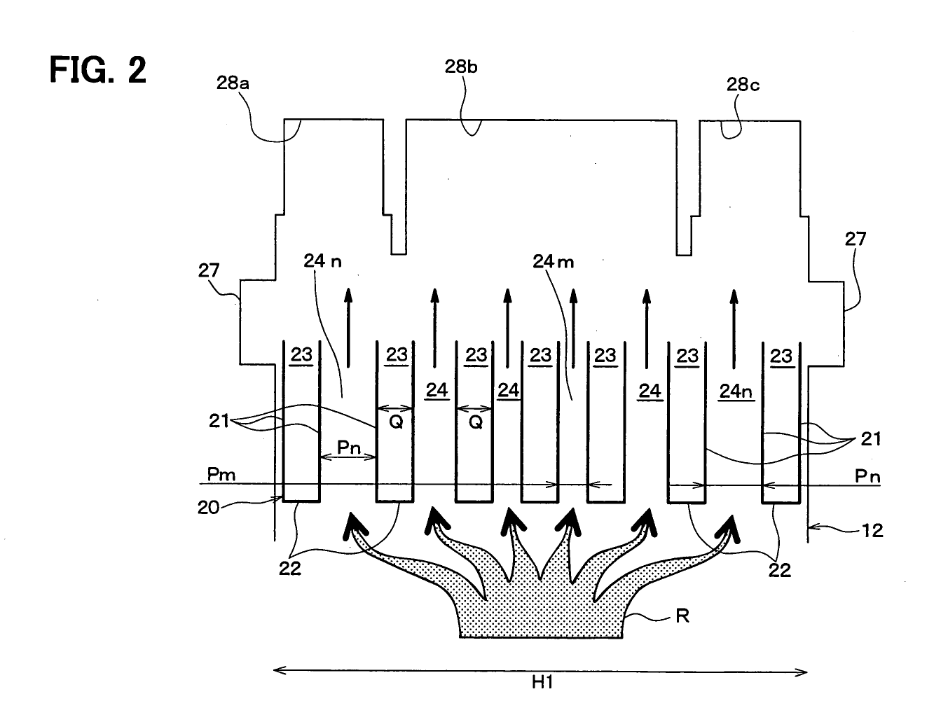

A first embodiment of the present invention will be described with reference to FIGS. 1 to 3. Referring to FIG. 1, an interior unit 10 of a vehicular air conditioning apparatus is mounted in a space defined in an instrument panel that is located at a front part of a passenger compartment of a vehicle, and at a substantially middle position with respect to a vehicle right and left direction. In the drawings, an up and down arrow and a front and rear arrow denote respective directions when the interior unit 10 is mounted in a vehicle. In FIG. 1, a direction perpendicular to a paper of FIG. 1 corresponds to a right and left direction of the vehicle (H1 in FIG. 2).

The interior unit 10 has a blower 11 at a front upper position. The blower 11 includes a fan 11a, a motor (not shown) for driving the fan 11a, and a scroll casing 11b. For example, the fan 11a is a centrifugal multi blade fan, such as a sirocco fan. The scroll casing 11b houses the fan 11a and forms a scroll passage. A nose portion 11c, which is a base point of a scroll passage, is located under the fan 11a. Also, an end 11d of the scroll passage is located in front of the nose portion 11c across a predetermined distance. The end 11d of the scroll passage is in communication with a space 12a formed at a front portion of a unit case 12.

An inside/outside air switching box (not shown) is provided on a suction side of the fan 11a. The fan 11a draws air, such as inside air and outside air, from the inside/outside air switching box and blows the air into the scroll passage. Thus, the air flows into the space 12a of the unit case 12 in a substantially downward direction as shown by an arrow a in FIG. 1.

The unit case 12 forms an air passage through which the air blown by the fan 11a flows. For example, the unit case 12 is made of resin, and is constructed by fastening plural case members with fastening means such as screws and metal spring clips.

The unit case 12 houses an evaporator 13 as a cooling heat exchanger under the fan 11a. For example, the evaporator 13 is arranged in a vertical direction such that front and rear surfaces of a core part extend in the up and down direction. Thus, the air blown by the fan 11a fully passes through the core par of the evaporator 13 in a vehicle rearward direction.

Although not illustrated, the core part has flat tubes and corrugated fins for increasing heat exchange surfaces of air. The flat tubes and the corrugated fins are alternately stacked and joined together. The flat tubes form refrigerant passages therein through which a low pressure refrigerant, which has been decompressed by decompression means (not shown) of a refrigerant cycle, flows. The evaporator 13 performs heat exchange between the low pressure refrigerant and the air blown by the fan 11a, thereby to cool the air.

The unit case 12 has a drain port 14 under the evaporator 13 for draining condensation of the evaporator 13. For example, the drain port 14 is located at a lowermost position within the unit case 12.

A heater core 15 as a heating heat exchanger is disposed in the unit case 12, at a position downstream of the evaporator 13, that is, on a rear side of the evaporator 13. For example, the heater core 15 is inclined in the rearward direction such that a distance between an upper end of the heater core 15 and the rear surface of the evaporator 13 is larger than a distance between a lower end of the heater core 15 and the rear surface of the evaporator 13. That is, the evaporator 13 and the heater core 15 are arranged to form a substantially V-shape when viewed in the vehicle right and left direction.

Here, the length (height) of the heater core 15 is smaller than the length (height) of the evaporator 13, and the lower end of the heater core 15 is located adjacent to a lower end of the evaporator 13. Thus, a cooled air bypass passage 16 is formed between an upper end of the evaporator 13 and the upper end of the heater core 15 for allowing the cooled air to flow while bypassing the heater core 15.

In other words, the evaporator 13 and the heater core 15 are arranged such that the lower ends thereof are located close to each other and to correspond to the bottom of the V-shape and the upper ends thereof are separated from each other. Thus, the cooled air bypass passage 16 is formed in a substantially middle portion of the V-shape.

The heater core 15 is a heated-fluid type heat exchanger, and heats the cooled air using heat of a heat medium such as an engine coolant flowing inside of the heater core 15. The heater core 15c has a core part for performing heat exchange. The core part 15c has flat tubes through which the heat medium flows and corrugated fins for increasing heat exchange surfaces of the air. The flat tubes and the corrugated fins are alternately stacked in the right and left direction and joined together.

The heater core 15 has tanks 15d, 15e at the ends of the core part 15c. The heat medium is separated into the tubes from one of the tanks 15d, 15e and is collected in the other one of the tanks 15d, 15e after passing through the tubes. In the example shown in FIG. 1, the lower tank 15e serves as an inlet tank and the upper tank 15e serves as an outlet tank.

Thus, the heat medium flows into the lower tank 15e from an inlet pipe (not shown) and is separated into the tubes. The heat medium passes through the tubes in the upward direction and flows into the upper tank 15d. Then, the heat medium flows out from the heater core 15 and flows toward an engine of the vehicle.

The heater core 15 is held between an upper support portion 12c and a lower portion of the unit case 12. An air mix door 17 is rotatably supported between the evaporator 13 and the heater core 15. For example, the air mix door 17 is a plate door having a plate-like door body and a rotation shaft 17a at an end of the door body. The air mix door 17 is rotatable about the rotation shaft 17a.

The rotation shaft 17a is located adjacent to and in front of the upper end of the heater core 15, and extends in the vehicle right and left direction. Ends of the rotation shaft 17a are rotatably supported in shaft-receiving portions (not shown) formed on right and left side walls of the unit case 12.

One of the ends of the rotation shaft 17a projects outside of the unit case 12 and is coupled to a temperature adjustment operation device (not shown) so that the air mix door 17 is rotated by an operation force from the temperature adjustment operation device. For example, the temperature adjustment operation device is an actuator device including a servomotor.

The air mix door 17 is movable between a maximum heating position 17b shown by a chain dashed line in FIG. 1 and a maximum cooling position 17c shown by a dashed line in FIG. 1. When the air mix door 17 is at the maximum heating position 17b, the cooled air bypass passage 16 is fully closed and a heated air passage 18 through which the air passing through the core part 15c of the heater core 15 flows is fully open. On the other hand, when the air mix door 17 is at the maximum cooling position 17c, the cooled air bypass passage 16 is fully open and the heated air passage 18 is fully closed.

The air mix door 17 is provided as temperature control means for controlling a temperature of air to be blown into a passenger compartment. Namely, a ratio of the volume of the heated air passing through the core part 15c of the heater core 15 as shown by an arrow c to the volume of the cooled air passing through the cooled air bypass passage 16 as shown by an arrow b is controlled by the air mix door 17.

The unit case 12 further has an air mix space 19 as an air mix part at a position downstream of the heater core 15, such as, on a rear portion of the unit case 12. The heated air passage 18 and the cooled air bypass passage 16 merge together in the air mix space 19. Thus, the heated air shown by the arrow c and the cooled air shown by the arrow b are mixed in the air mix space 19.

Further, a baffle member 20 is disposed in the air mix space 19 for facilitating the mixture of the cooled air (arrow b) and the heated air (arrow c). A structure of the baffle member 20 will be described later in detail.

The unit case 12 has air-blowing openings, such as foot openings 27, face openings 28, and a defroster opening 29, at positions downstream of the air mix space 19 for blowing a conditioned air, which has passed through the air mix space 19 toward different positions of the passenger compartment. In the example shown in FIG. 1, the air-blowing openings 27, 28, 29 are located substantially above the air mix space 19.

The foot openings 27 are located immediately above the air mix space 19. The foot openings 27 are formed on the right and left side walls of the unit case 12, respectively. The right and left foot openings 27 are opened or closed by foot doors 30. The foot doors 30 are, for example, plate doors, and are rotatable about rotation shafts 30a.

Right and left foot ducts (not shown) are respectively coupled to the right and left foot openings 27. The right and left foot ducts have foot outlets at downstream position thereof. Thus, the conditioned air (mainly warm air) is blown from the foot outlets toward lower areas of the passenger compartment, such as passenger foot areas.

The face openings 28 are located at a rear portion of an upper wall of the unit case 12. For example, the face openings 28 are three openings, such as left and right side face openings 28a, 28c and a center face opening 28b, as shown in FIG. 2. The face openings 28a, 28b, 28c are aligned in the vehicle right and left direction H1.

The face openings 28a, 28b, 28c are opened and closed by face doors, respectively. Each of the face doors is, for example, a plate door, and is rotatable about a rotation shaft. In FIG. 1, only the face door 32 of the left side face opening 28a is exemplary illustrated. The face door 32 is rotatable about a rotation shaft 32a.

Face ducts (not shown) are coupled to the face openings 28a, 28b, 28c, respectively. The face ducts have face outlets at ends thereof, so that the conditioned air is blown toward upper areas of the passenger compartment, such as, upper bodies of passengers.

The defroster opening 29 is located on a front side of the face openings 28. The defroster opening 29 is opened and closed by a defroster door 34. The defroster door 34 is, for example, a plate door, and is rotatable about a rotation shaft 34a.

A defroster duct (not shown) is coupled to the defroster opening 29. The defroster duct has a defroster outlet at its end, so that the conditioner air is blown toward an inner surface of a windshield of the vehicle.

Here, the foot doors 30, the face doors 32 and the defroster door 34 are provided as air-blowing mode doors. The rotation shafts 30a, 32a, 34a of the doors 30, 32, 34 are disposed such that ends thereof project outside of the unit case 2 and coupled to the same air-blow mode operation mechanism through a linking device.

As such, air-blow modes are switched by rotating the foot doors 30, the face doors 32 and the defroster door 34 by the mode operation mechanism through the linking device. For example, the mode operation mechanism is constructed of an actuator device including a servomotor.

Next, structures of the baffle member 20 and the face openings 28a, 28b, 28c will be described with reference to FIG. 1.

As shown in FIG. 2, the baffle member 20 is a device or member that is capable of allowing two kinds of airflows having different temperatures to pass through. That is, the baffle member 20 forms two kinds of passages (first passages and second passages) through which airs having different temperatures to flow.

For example, the baffle member 20 includes fourteen separation plates 21 that are arranged at predetermined intervals in the vehicle right and left direction H1. Also, the separation plates 21 extend in a direction parallel to the cooled air flow, such as, in an up and down direction of FIG. 2.

The separation plates 21 provide seven heated air main-flow passages 23 through which the heated air that has passed through the heated air passage 18 mainly flows and six cooled air main-flow passages 24 (24m, 24n) through which the cooled air that has passed through the bypass passage 16 mainly flows. The heated air main-flow passages 23 and the cooled air mail-flow passages 24 (24m, 24n) are alternately arranged in the vehicle right and left direction H1.

The seven heated air main-flow passages 23 are open to the heated air passage 18. A blocking plate 22 is disposed at an upstream portion of each of the heated air main-flow passages 23 for restricting the cooled air (e.g., arrow R) from flowing into the heated air main-flow passage 23. Also, each blocking plate 22 is disposed between two separation plate 21 that define the heated air main-flow passage 23. Therefore, the heated air passing through the heated air passage 18 flows in the heated air main-flow passage 23 in a direction perpendicular to the paper of FIG. 2, and flows out the heated air main-flow passages 23 in an upward direction of FIG. 2.

The width Q of the seven heated air main-flow passages 23 with respect to the right and left direction H1 is substantially equal. Also, the depth of the seven heated air main-flow passages 23, that is, a dimension in a direction perpendicular to the right and left direction H1 is substantially equal.

The heated air main-flow passages 23 and the cooled air main-flow passages 24 (24m, 24n) are arranged in a direction parallel to the alignment direction of the face openings 28a, 28b, 28c. In the example shown in FIGS. 1 and 2, the alignment direction of the face openings 28a, 28b, 28c is parallel to the vehicle right and left direction H1. Thus, the heated air main-flow passages 23 and the cooled air main-flow passages 24 are arranged in the vehicle right and left direction H1.

The six cooled air main-flow passages 24 (24m, 24n) are not provided with the blocking plates 22. The six cooled air main-flow passages 24 (24m, 24n) are open to the cooled air bypass passage 16 and the heated air passage 18. Therefore, the cooled air from the cooled air bypass passage 16 and the heated air from the heated air passage 18 flow in the cooled air main-flow passages 24 (24m, 24n) and are mixed together therein.

In the unit case 12, the volume of the heated from the heater core 15 is smaller than the volume of the cooled air passing through the cooled air bypass passage 16 due to a configuration of the unit case 12 and pressure loss of the heater core 15. Therefore, the cooled air mainly flows in the cooled air main-flow passages 24 (24m, 24n).

The depth of the six cooled air main-flow passages 24 (24m, 24n), that is, the dimension of the six cooled air main-flow passages 24 in a direction perpendicular to the vehicle right and left direction H1, is substantially equal. However, the width of the cooled air main-flow passages 24 with respect to the vehicle right and left direction H1 are varied in the following manner.

Side cooled air main-flow passages 24n, which are located on side ends with respect to the vehicle right and left direction H1, that is, located closer to the side walls of the unit case 12, have the width Pn larger than the width Pm of middle cooled air main-flow passages 24m that are located at a middle portion with respect to the vehicle right and left direction H1.

For example, the baffle member 20 is formed of a resin. Also, the baffle member 20 is formed separately from the unit case 12, and then is integrated with the unit case 12. The baffle member 20 is fixed to inner surfaces of the rear portion of the unit case 12 by a predetermined fixing structure or a method, such as, by press-fitting or bonding. Alternatively, the baffle member 20 may be integrally molded with inner walls of the rear portion of the unit case 12.

Next, an operation of the interior unit 10 will be described. When an air volume switch of the air conditioning apparatus is turned on, an electric power is supplied to the motor of the blower 11 and the fan 11 is driven. Thus, the fan 11a draws the inside air or the outside air through the inside/outside air switching box and blows the air into the scroll passage. Further, the air flows toward the space 12a of the unit case 12 in the downward direction as shown by the arrow a.

The air fully passes through the evaporator 13 in the vehicle rearward direction and is cooled. Then, the cooled air is separated into the cooled air bypass passage 16 (arrow b) and the heated air passage 18 (arrow c) to be heated by the heater core 15. Further, the cooled air passing through the cooled air bypass passage 16 and the heated air heated by the heater core 15 merge with each other in the air mix space 19. Thus, the heated air and the cooled air are mixed to be the conditioned air having a predetermined temperature.

Namely, the ratio of the volume of the cooled air (arrow b) to the heated air (arrow c) is adjusted by controlling an opening degree of the air mix door 17, that is, the position of the air mix door 17. Therefore, the temperature of the air to be blown into the passenger compartment is controlled to a desired temperature.

The conditioned air is introduced to at least one of the foot openings 27, the face openings 28 and the defroster opening 29 and blown into the passenger compartment. Accordingly, an air conditioning operation of the passenger compartment is performed. Also, a fog-restricting or defrosting operation of the windshield is performed.

Next, an air mixing operation and effects of the baffle member 20 will be described. The heated air flows in the heated air main-flow passages 23 from the heated air passage 18, and flows out from the heated air main-flow passages 23. On the other hand, the heated air and the cooled air flow in the six cooled air main-flow passages 24 (24m, 24n). The heated air and the cooled air are mixed together in the cooled air main-flow passages 24 (24m, 24n), and then flow out from the cooled air main-flow passages 24 (24m, 24n).

Here, the width Pn of the side cooled air main-flow passages 24n is greater than the width Pm of the middle cooled air main-flow passages 24m. For example, as shown by an arrow R in FIG. 2, a part of the cooled air that flows through a middle portion with respect to the right and left direction H1 at a position upstream of the baffle member 20 separates in the right and left direction H1, and flows in the cooled air main-flow passages 24.

As such, at the position upstream of the baffle member 20, that is, at a position upstream of the heated air main-flow passages 23 and the cooled air main-flow passages 24, even when the flow speed of the cooled air is higher at the middle portion with respect to the right and left direction H1 than at the side ends (right and left sides in FIG. 2), the volumes of the cooled airs flowing into the six cooled air main-flow passages 24 (24m, 24n) are substantially uniform.

Thereafter, the mixed air passing through the six cooled air main-flow passages 24 (24m 24n) and the heated air passing through the heated air main-flow passages 23 are mixed together, and then introduced into the passenger compartment through at least one of the air-blowing openings 27 to 29.

In the first embodiment, as described in the above, the width Pn of the side cooled air main-flow passages 24n is greater than the width Pm of the middle cooled air main-flow passages 24m. Therefore, a part of the cooled air separates in the right and left direction H1 from the middle portion, and can reach the side cooled air main-flow passages 24n, as shown by the arrow R.

In this case, the widths of the cooled air-main flow passages 24 (24m, 24n) are varied according to a distribution of a flow speed of the cooled air at the position upstream of the baffle member 20. That is, the width Pn of the side cooled air main-flow passages 24n that are located at positions corresponding to a relatively low flow speed in the cooled air upstream of the baffle member 20 (hereafter, simply the upstream cooled air) is larger than the width Pm of the middle cooled air main-flow passages 24m that are located at positions corresponding to a relatively high flow speed.

As such, at the position upstream of the baffle member 20, even if the flow speed of the upstream cooled air is higher at the middle position with respect to the right and left direction H1 than at the side ends, the volumes of the cooled airs flowing into the six cooled air main-flow passages 24 (24m, 24n) are substantially uniform.

On the other hand, in a case where the cooled air main-flow passages 24 have the same width with respect to the right and left direction H1, if the upstream cooled air has uneven distribution of its flow speed or flow rate with respect to the right and left direction H1, the cooled air passes through the six cooled air main-flow passages 24 while maintaining the uneven temperature distribution of the flow speed.

That is, in the case where the cooled air main-flow passages 24 have the same width, if the flow speed of the upstream cooled air is higher at the middle position than at the side ends, the volume of the cooled air passing through the middle cooled air main-flow passages is greater than the volume of the cooled air passing through the side cooled air main-flow passages.

Therefore, the mixed air passing through the cooled air main-flow passages 24 is mixed with the heated air passing through the heated air main-flow passages 23 while maintaining the uneven distribution of the volumes. As a result, uneven temperature distribution occurs in the mixed air at the downstream position of the baffle member 20. That is, at the position downstream of the baffle member 20, the temperature of the mixed air at the middle portion is lower than that of the mixed air at the right and left ends. Therefore, the temperature of the air blown from the center face opening 28b is lower than that of the air blown from the side face openings 28a, 28c.

In the first embodiment, on the other hand, the widths of the cooled air main-flow passages 24 (24m, 24n) are adjusted according to the distribution of the flow speed of the upstream cooled air so that the upstream cooled air is uniformly introduced into the six cooled air main-flow passages 24 (24m, 24n). Therefore, unevenness of temperature of the mixed air at the position downstream of the baffle member 20 is reduced. With this, the temperature difference between the air blown from the side face openings 28a, 28c and the air blown from the center face opening 28b is reduced. As a result, an air conditioning operation comfortable for a passenger is performed.

For example, the following methods (1), (2) are considered to solve the uneven distribution of the flow speed of the cooled air, instead of the above method of differentiating the widths of the cooled air main-flow passages 24. In the method (1), ribs are provided within the middle cooled air main-flow passages 24m such that the volumes of the cooled airs flowing into the middle cooled air main-flow passages 24m reduce. In the method (2), blocking members or guide members for correcting the air flow direction are provided at the position upstream of the baffle member 20 such that the volumes of the cooled airs flowing into the middle cooled air main-flow passages 24m reduce.

However, in the method (1), a structure of the baffle member 20 is complicated. Also, because cross-sectional areas of the middle cooled air main-flow passages 24m are reduced, pressure loss is likely to be increased. Further, pressure loss and noise will be increased due to swirl and separation. Also in the method (2), pressure loss and noise will be increased due to swirl and separation. Further, a size of the air conditioning apparatus will be increased.

In the first embodiment, the width of at least one of the cooled air main-flow passages 24 (24m, 24n) is differentiated. Thus, the structure of the baffle member 20 is still simple, and the total cross-sectional area of the cooled air main-flow passages 24m, 24n is substantially maintained. Therefore, a large increase in the pressure loss is restricted beforehand, and swirl and separation are reduced. That is, the further pressure loss and noise are reduced. In addition, an overall size of the baffle member 20 is not changed even when the widths of the cooled air main-flow passages 24m, 24n are differentiated. Therefore, this baffle member 20 does not cause an increase in the size of the air conditioning apparatus.

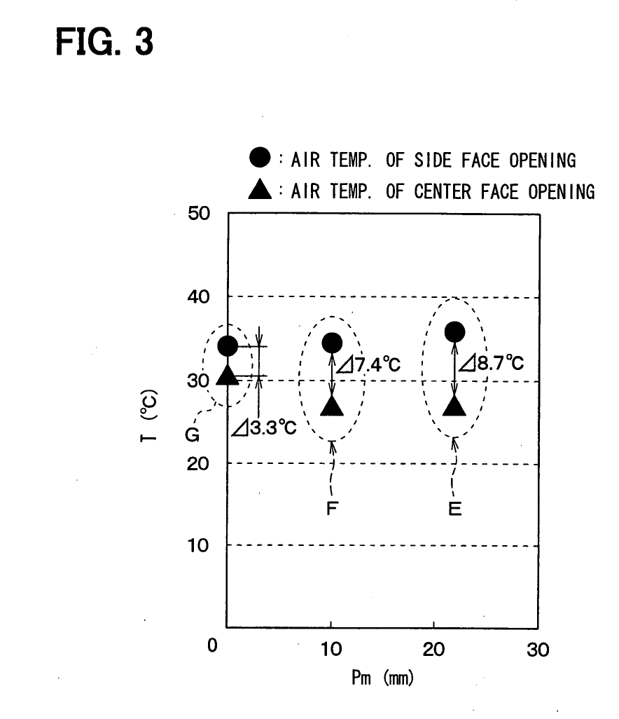

FIG. 3 shows test results of a change of temperature of the air passing through the side face openings 28a, 28c and a change of temperature of the air passing through the center face opening 28b, when the width Pm of the middle cooled air main-flow passages 24m is varied.

In FIG. 3, a horizontal axis represents the width Pm, and a vertical axis represents the temperature of the air, such as the temperature of the air passing through the side face openings 28a, 28c and the temperature of the air passing through the center face opening 28b. Symbols encompassed by a dashed line E represent the air temperatures when the widths Pm of the center face openings 24m are equal to the widths Pn of the side face openings 24n. Symbols encompassed by a dashed line F represent the air temperatures when the width Pm is smaller than the width Pn. Also, symbols encompassed by a dashed line G represent the air temperatures when the width Pm is further smaller than the width Pn.

As shown in FIG. 3, temperature difference between the air passing through the side face openings 28a, 28c and the air passing through the center face opening 28b reduces as the width Pm reduces.

### Second Embodiment

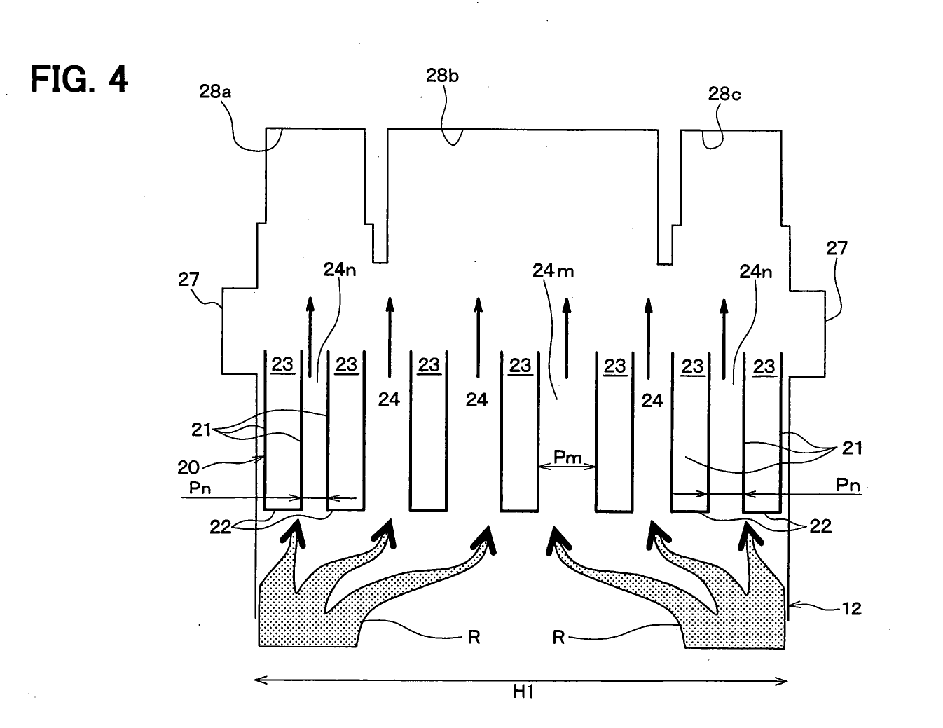

A second embodiment will be described with reference to FIG. 4. In the first embodiment, the example in which the flow speed of the upstream cooled air is higher at the middle portion than at the right and left ends is described. On the other hand, in the second embodiment, an example in which the flow speed of the upstream cooled air is lower at the middle portion than at the right and left ends will be described.

In an example shown in FIG. 4, the baffle member 20 has the six cooled air main-flow passages 24 (24m, 24n). The cooled air main-flow passages 24n, which are located closer to the side walls of the unit case, 12, that is, located at positions corresponding to a relatively high flow speed, have the width Pn. The cooled air main-flow passages 24m, which are located at positions corresponding to a relatively low flow speed, have the width Pm. The width Pn of the side cooled air-main-flow passages 24n is smaller than the width Pm of the middle main-flow passages 24m.

For example, as shown by arrow R, portions of the upstream cooled air separate from the right and left ends toward the middle portion with respect to the right and left direction H1, and can reach the middle cooled air main-flow passages 24m. Therefore, even when the flow speed of the upstream cooled air is higher at the right and left ends than at the middle portion, at the position upstream of the baffle member 20, the volumes of the cooled air flowing into the six cooled air main-flow passages 24 (24m, 24n) are substantially uniform. Accordingly, the similar effects as the first embodiment will be provided.

### Third Embodiment

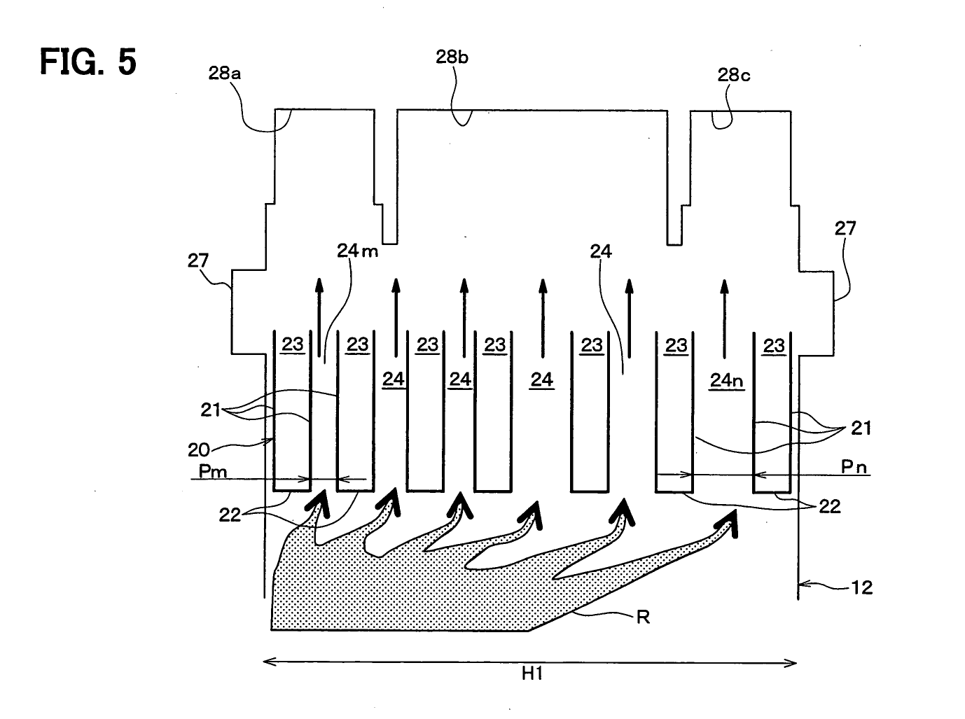

A third embodiment will be described with reference to FIG. 5. In the first embodiment, the example in which the flow speed of the upstream cooled air is higher at the middle portion than the right and left ends is described. On the other hand, in the third embodiment, an example in which the flow speed of the upstream cooled air is higher at one of the right and left ends than the other end will be described.

In the example shown in FIG. 5, the flow speed of the upstream cooled air is higher at the left end than at the right end. In this case, left cooled air main-flow passages 24m, which are located on a left side where the flow speed of the upstream cooled air is relatively high, has a width Pm. Right cooled air main-flow passages 24n, which are located on a right side on which the flow speed of the cooled air is relatively low, has a width Pn. The width Pn is larger than the width Pm.

Therefore, a part of the upstream cooled air separates from the left side toward the right side, and reaches the right cooled air main-flow passages 24n, as shown by the arrow R. As such, even when the flow speed of the cooled air is higher at one of the right and left sides than the opposite side, the volumes of the cooled airs flowing into the six cooled air main-flow passages 24 (24m, 24n) are substantially uniform. Accordingly, the similar effects as the first embodiment will be described.

### Fourth Embodiment

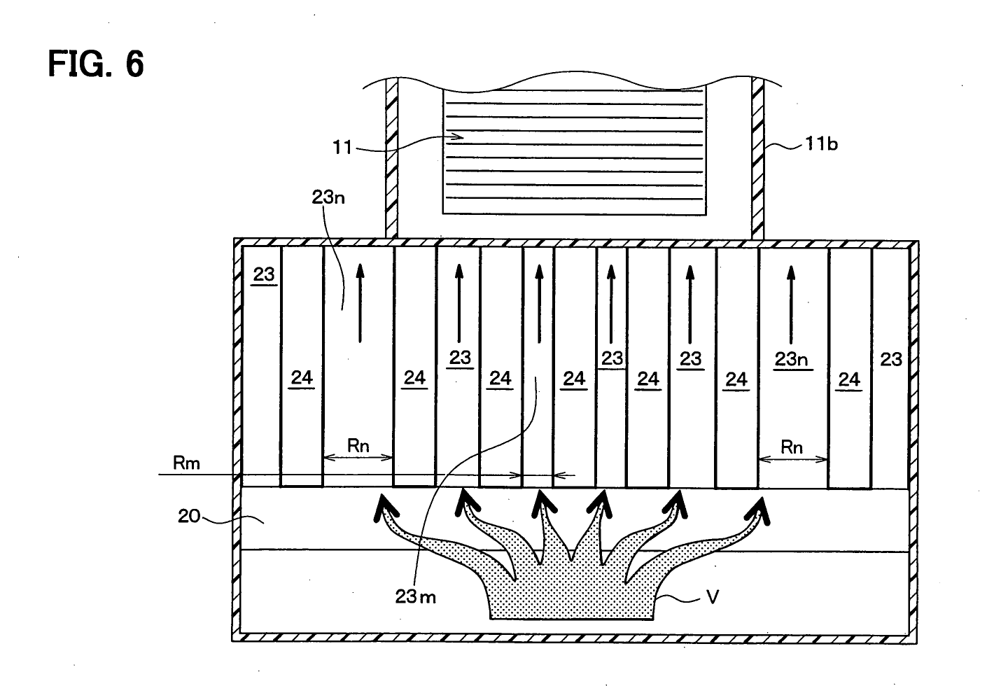

A fourth embodiment will be described with reference to FIG. 6. In the above embodiments, the examples in which the cooled air has uneven distribution of the flow speed at the position upstream of the baffle member 20 are described. In the fourth embodiment, on the other hand, an example in which the heated air flow has uneven distribution of its flow speed at the position upstream of the baffle member 20. FIG. 6 shows a cross-section of the air conditioning apparatus of the fourth embodiment taken at a position corresponding to a line VI-VI in FIG. 1.

For example, the flow speed of the heated air at the position upstream of the baffle member 20 (hereafter, upstream heated air) is higher at the middle portion than at the right and left ends. In this case, the widths of the cooled air main-flow passages 24 are substantially equal. On the other hand, right and left heated air main-flow passages 23n, which are located close to the right and left ends of the unit case 12, have the width Rn that is greater than the width Rm of the middle heated air main-flow passages 23m.

A part of the upstream heated air (arrow V) that generally flows at the middle portion with respect to the right and left direction separates from the middle portion toward the right and left ends, and reaches the right and left heated air main-flow passages 23n. As such, even when the flow speed of the upstream heated air is higher at the middle portion than the right and left ends, the volumes of the heated airs flowing into the heated air main-flow passages 23 (23m, 23n) are substantially uniform.

Therefore, unevenness of the temperature of the mixed air at the position downstream of the baffle member 20 is reduced. With this, temperature difference between the air passing through the side face openings 28a, 28c and the air passing through the center face opening 28b is reduced. Accordingly, an air conditioning operation comfortable for a passenger is performed.

In this embodiment, the example in which the flow speed of the upstream heated air is higher at the middle portion than at the right and left ends is described. In a case that the flow speed of the upstream heated air has a distribution different from the above, the widths of the heated air main-flow passages 23 (23m, 23n) may be varied in accordance with the distribution of the flow speed of the upstream heated air. For example, when the flow speed of the upstream heated air is higher at the right and left portions than at the middle portion, or when the flow speed of the upstream heated air is higher at one of the right and left portions than at the other end, the widths of the heated air main-flow passages 23 (23m, 23n) may be varied in accordance with the respective distributions of the flow speed.

In the example shown in FIG. 6, the second heated air main-flow passages 23n from the right and left side walls of the unit case 12 exemplarily have the greater widths Rn. The widths of the heated air main-flow passages 23 may be varied according to a condition in use, in addition to the distribution of the flow speed of the upstream heated air.

### Other Embodiments

In the above embodiments, the baffle member 20 has the heated air main-flow passages 23 through which the heated air passes and the cooled air main-flow passages 24 through which the cooled air and a small volume of the heated air pass as the first and second passages. However, the passage structure of the baffle member 20 is not limited to the above as long as two different kinds of passages through which airs having different temperatures are formed. For example, the baffle member 20 is configured such that only the cooled air from the cooled air bypass passage 16 flows in the cooled air main-flow passages 24 and the heated air from the heated air passage 18 flow in the heated air main-flow passages 23.

In the above embodiments, the face openings 28a, 28b, 28c are aligned in the vehicle right and left direction H1. However, the alignment direction of the face openings 28a, 28b, 28c is not limited to the above. That is, the baffle member 20 may be employed in a rear air conditioning apparatus in which a plurality of air-blowing openings is aligned in a vehicle front and rear direction. In this case, the fourteen separation plates 21 are arranged in the vehicle front and rear direction so that the heated air main-flow passages 23 and the cooled air main-flow passages 24 are alternately arranged in the alignment direction of the air-blowing openings.

In the above embodiments, the baffle member 20 is employed to improve the temperature distribution of the air blown from the face openings 28a, 28b, 28c. However, a purpose of the baffle member 20 is not limited to the face openings 28a, 28b, 28c. That is, the air-blowing openings are not limited to the face openings 28a, 28b, 28c. The baffle member 20 of the above embodiments may be employed to improve the temperature distribution of the air toward from any air-blowing openings that are generally aligned in one direction.

In the above embodiments, the baffle member 20 is exemplarily employed in the interior unit 10 that has the foot openings 27, the face openings 28 and the defroster opening 29 as the air-blowing openings and is used as a front air conditioner interior unit. The baffle member 20 of the above embodiments may be employed in a rear air conditioner interior unit without having the defroster opening.

The air mix door 17, the mode doors 30, 32, 34 may be constructed of other types of doors, in place of the plate doors. For example, the doors 17, 30, 32, 34 may be constructed of slide doors that slide in a direction substantially perpendicular to the air flow direction. The slide door may be a rigid door formed of a rigid material or a film door made of a flexible film material, for example.

The air mix door 17 may be constructed of two doors, such as a cooled air mix door for opening and closing the cooled air bypass passage 16 and a heated air mix door for opening and closing the heated air passage 18. The baffle member 20 may be employed in a unit case in which the temperature of the air to be introduced into the passenger compartment is controlled by another means, instead of the air mix door 17.

It is not always necessary that the interior unit 10 has both of the evaporator 13 and the heater core 15. That is, the baffle member 20 may be employed in an air conditioner interior unit without having the evaporator 13.

In the above embodiments, the number of the heated air main-flow passages 23 (23m, 23n) and the number of the heated air main-flow passages 24 (24m, 24n) are not limited to seven and six, respectively. Also, the widths of the heated air main-flow passages 23 (23m, 23n) and the cooled air main-flow passages 24 (24m, 24n) are varied in various ways for improving the temperature distribution of the air blown from the air-blowing openings that are arranged in the generally one direction.

Additional advantages and modifications will readily occur to those skilled in the art. The invention in its broader term is therefore not limited to the specific details, representative apparatus, and illustrative examples shown and described.

What is claimed is:

1. An air conditioning apparatus for a vehicle, comprising:
a unit case;
a first heat exchanger disposed in the unit case for generating a heated air;
a bypass passage provided in the unit case for allowing a bypass air to bypass the first heat exchanger;
an air mix door disposed in the unit case and operable to control a ratio of a volume of the bypass air to a volume of the heated air, thereby to control a temperature of air to be introduced into a passenger compartment of the vehicle;
a plurality of openings provided by the unit case, the plurality of openings aligned in an alignment direction; and
a baffle member disposed in the unit case and defining a plurality of first passages and a plurality of second passages, the plurality of first passages and the plurality of second passages alternately disposed in the alignment direction, wherein:
one of the bypass air and the heated air has an uneven distribution of a flow speed with respect to the alignment direction at a position upstream of the baffle member, the one flowing in the plurality of first passages, and the other of the bypass air and the heated air flowing in the plurality of second passages; and
one of the first passages that is located at a position corresponding to a relatively low flow speed has a width with respect to the alignment direction greater than a width of another one of the first passages that is located at a position corresponding to a relatively high flow speed.

2. The air conditioning apparatus according to claim 1, wherein
the plurality of second passages has substantially equal widths with respect to the alignment direction.

3. The air conditioning apparatus according to claim 1, wherein
the baffle member includes a plurality of separation walls and a plurality of blocking walls,
the plurality of separation walls is arranged in the alignment direction such that the plurality of first passages and the plurality of second passages are separated from each other,
the plurality of blocking walls is disposed in the plurality of second passages to restrict the one having the uneven distribution from flowing into the plurality of second passages.

4. The air conditioning apparatus according to claim 1, wherein the one having the uneven distribution is the bypass air.

5. The air conditioning apparatus according to claim 4, wherein
the flow speed of the bypass air is higher at a substantially middle portion than at ends with respect to the alignment direction.

6. The air conditioning apparatus according to claim 4, wherein
the flow speed of the bypass air is lower at a substantially middle portion than at ends with respect to the alignment direction.

7. The air conditioning apparatus according to claim 1, wherein the one having the uneven distribution of the flow speed is the heated air.

8. The air conditioning apparatus according to claim 7, wherein
the flow speed of the heated air is higher at a substantially middle portion than at ends with respect to the alignment direction.

9. The air conditioning apparatus according to claim 1, further comprising:
a second heat exchanger disposed upstream of the first heat exchanger in the unit case for generating a cooled air, wherein
the first heat exchanger is disposed to heat the cooled air, and
the bypass passage is disposed to allow the cooled air to flow while bypassing the first heat exchanger.

10. The air conditioning apparatus according to claim 1, wherein
the unit case is disposed such that the alignment direction is substantially parallel to a right and left direction of the vehicle.

11. A vehicular air conditioning apparatus, comprising:
a unit case;
a heat exchanger disposed in the unit case for generating a heated air;
a bypass passage provided in the unit case for allowing a bypass air to bypass the first heat exchanger;
a baffle member disposed in the unit case at a position downstream of the first heat exchanger and the bypass passage; and
a plurality of openings provided by the unit case at a position downstream of the baffle member, the plurality of openings aligned in an alignment direction across a width of the unit case, wherein:
the baffle member defines a plurality of first passages and a plurality of second passages, the plurality of first passages and the plurality of second passages are alternately disposed in the alignment direction;
in the unit case, one of the bypass air and the heated air has an uneven distribution of a flow speed with respect to the alignment direction at a position upstream of the baffle member due to a configuration of the unit case, the one flowing in the plurality of first passages, and the other of the bypass air and the heated air flowing in the plurality of second passages; and
widths of the plurality of first passages in the alignment direction are varied according to the flow speed.
